(19) United States
(12) Patent Application Publication
(10) Pub. No.: US 2002/0071677 A1
(43) Pub. Date: Jun. 13, 2002

(54) Indexing and database apparatus and method for automatic description of content, archiving, searching and retrieving of images and other data

(76) Inventor: Thilaka S. Sumanaweera, San Jose, CA (US)

Correspondence Address: Law Offices of K. W. Float, Box 80790, Rancho Santa Margarita, CA, 92688-0790, US

(21) Appl. No.: 09/734,356

(22) Filed: Dec. 11, 2000

(51) Int. Cl. G03B 17/48

(52) U.S. Cl. 396/429

(57) ABSTRACT

An indexing database apparatus and methods provide a way to automatically label, catalog and describe the content of images and other data using position, orientation, field of view and time of capture using a camera or a sensor. The present invention automatically generates a description of the content of an image or other data by querying a description database indexed to parameters such as location, orientation, field of view and time or a subset thereof recorded with images and other data. An exemplary apparatus comprises a GPS receiver for sensing the location of a camera or sensor, an angular position sensor for sensing the orientation of the axis of the camera or sensor, a field of view sensor for sensing the field of view of the camera or sensor and a clock for indicating the time of image or data capture. A recording medium records the image or other data and the above parameters. A display subsystem including a computer, a monitor, and at least one computer program, displays the image or other data along with the description of the content of the images or other data on a monitor. An indexing database apparatus and methods also provide means for archiving images or other data, its parameters and a description of its content in a database. The present invention also provides a way to search and retrieve images or other data from a database based on the content of the images or other data.

### BACKGROUND

The present invention relates generally to imaging, and more particularly, to indexing and database apparatus and methods that provide for automatic labeling, cataloging and describing the content of images and other data using position, orientation, field of view, time and other data recorded with the images. The present invention also relates to indexing and database apparatus and methods that provide for archiving, searching and retrieving images and other data based on descriptions of their content.

In the past, when people take photographs, they need to write down where the photographs are taken for future reference. When people are traveling, it takes some special effort to write a description of the images down. Often, people return home, develop and/or upload the pictures to a computer several days later. By that time, people have generally forgotten where the photographs have been taken and which objects and scenes the photographs contain.

Furthermore, if someone wants to search a database containing images and retrieve all the pictures of a particular object or scene, say for example, Big Ben, currently a computer has to analyze the pictures by running post-processing filters such as edge detectors, pattern matching filters, or the like, and then use elaborate schemes such as Bayesian reasoning to automatically identify images containing Big Ben. Even then it is an extremely difficult task for a computer to recognize pictures automatically and reliably. Researchers in the field of artificial intelligence have spent decades attempting to solve the problem of image understanding by computer. A reliable and consistent solution to this problem is still not within reach.

One goal of the present invention is to automatically label, catalog and describe the content of photographs and other data, using position, orientation, field of view and other data of the camera or the sensor when the photograph or the data was captured. Another goal of the present invention is to archive, search and retrieve images and other data in databases based on their content.

Known prior art related to the present invention includes U.S. Pat. No. 5,768,640 entitled “Camera having an information recording function”, issued to Yoshiharu et al. The Yoshiharu et al. patent discloses apparatus for recording a photographed image on a recording medium together with information received from a satellite of the Global Positioning System (GPS). The apparatus includes a first memory that stores recording data on the recording medium, a second memory that stores the information received thereafter by a GPS receiver, and a judging circuit that determines whether the later recording data is to be shifted from the second memory to the first memory when the shutter is actuated.

While the Yoshiharu et al. patent provides for recording of images and GPS data, there is no provision for automatically labeling, cataloging and describing images, nor is there any provision for archiving, searching and retrieving images in databases based on their content. It would be desirable to have an indexing and database apparatus and method for automatically labeling, cataloging and describing the content of images and other data. It would also be desirable to record the labeling and cataloging data and a description of the content of the images and other data in a database and provide means for archiving, searching and retrieving the images and other data based on their content.

### SUMMARY OF THE INVENTION

To accomplish the above and other objectives, the present invention provides for indexing and database apparatus for automatically labeling, cataloging and describing the content of images and other data. The present invention also provides for indexing and database apparatus for recording the labeling and cataloging data and descriptions of the content of the images and other data in a database. Furthermore, the present invention provides indexing and database apparatus for searching and retrieving the images and other data based on their content.

The present invention assumes that position and orientation of a camera or sensor that captures images or other data are recorded with the images or other data using a technique such as is described in U.S. Pat. No. 5,768,640 or any other similar technique. The position data may be gathered using GPS transmitters and receivers, triangulation of the location using radio transmitting or receiving antenna towers, or any other technique.

A capturing and recording subsystem comprises a GPS receiver for detecting the location, (x, y, z), of the camera or sensor, an angular position sensor for detecting the orientation, (α, β, θ), of the axis of the camera or sensor, an apparatus for detecting the field of view, (a, e) of the camera of sensor, and an apparatus for detecting the time, t, when the images or other data are captured. A recording medium 11 is used to record the image or other data and parameters, (x, y, z, α, β, θ, a, e, t), indicative of the location, orientation and field of view of the camera or sensor and the time when the images or other data are captured.

A display subsystem and a description database subsystem are provided for displaying the images or other data along with a description of the content of the images or other data. The display subsystem comprises a computer and a monitor and at least one computer program. The description database subsystem comprises a computer program and a database. The computer extracts the parameters (x, y, z, α, β, θ, a, e, t) from the recording medium corresponding to an image or other data, queries the description database server program to obtain a description of the content of the image or other data from the database and displays the images or other data and the description of the content on the monitor.

In general, an exemplary method comprises recording an image or other data, position, orientation, field of view and time data (in an image header, for example). The recording medium can be analog, such as photographic film or analog video tape, or digital, such as random access memory (RAM), compact disc read only memory (CD ROM), digital video disc (DVD) or digital video tape. Subsequent to recording, the image or other data and the position, orientation, field of view and time data are digitized if the recording medium is analog, the image or other data is transferred to a display system comprising a computer and monitor for viewing, and the position, orientation, field of view and time data are selectively processed to generate a description of the content of the recorded image or other data. The description is generated using a description database program and a description database containing a textual, diagrammatic and/or pictorial description indexed to the parameters (x, y, z, α, β, θ, a, e, t) or any subset thereof. The description is displayed along with the image or other data. The image or other data and description are stored in the computer memory.

In implementing the present method, one embodiment involves sending the parameters (x, y, z, α, β, θ, a, e, t) or a subset thereof relating to the image or other data to a description database server program that queries a description database, receiving a description of the viewpoint and/or surroundings of the objects in the image or other data, and displaying the received description on a monitor, storing the description in a local memory and/or sending it off to another computer for further processing and storage.

Another embodiment records the parameters (x, y, z, α, β, θ, a, e, t) or a subset thereof and data acquired using a sensor that captures and records sound, ultrasound, diagnostic medical ultrasound, X-ray, magnetic resonance imaging (MRI), computed tomography (CT), radar, sonar, motion pictures, or electronic representations of smell and taste, wherein the (x, y, z) data are acquired using a GPS receiver or a technique using triangulation of radio transmitting or receiving antenna towers.

Another embodiment sends the parameters (x, y, z, α, β, θ, a, e, t) or a subset thereof and data acquired using a sensor that captures and records sound, ultrasound, diagnostic medical ultrasound, X-ray, MRI, CT, radar, sonar, motion pictures, or electronic representations of smell and taste, to a description database program that queries a description database, receives a description of the viewpoint and/or surroundings of the sensor and/or objects in the data itself, displays the received description on a monitor, stores the description in a local memory and/or sends it off to another computer for further processing and storage.

Another embodiment searches databases containing data corresponding to images, sound, ultrasound, diagnostic medical ultrasound, X-ray, MRI, CT, radar, sonar, motion pictures, or electronic representations of smell and taste for keywords using parameters (x, y, z, α, β, θ, a, e, t) or a subset thereof, translates the parameters into a description of the data using a description database server, matches keywords to the description, and displaying the matching description with the corresponding data.

### BRIEF DESCRIPTION OF THE DRAWINGS

The various features and advantages of the present invention may be more readily understood with reference to the following detailed description taken in conjunction with the accompanying drawings, wherein like reference numerals designate like structural element, and in which:

FIG. 1 is a block diagram that illustrates exemplary apparatus in accordance with the principles of the present invention;

FIG. 2 illustrates operation of the present invention;

FIG. 3 illustrates an exemplary set of parameters that can be used to automatically extract descriptions of the content in images in accordance with the principles of the present invention.

FIG. 4 is a flow diagram illustrating an exemplary method in accordance with the principles of the present invention for use in searching and retrieving images based on their content; and

FIG. 5 is a flow diagram illustrating an exemplary method in accordance with the principles of the present invention for use in archival of images based on their content.

### DETAILED DESCRIPTION

The present invention builds upon techniques such as those described in the U.S. Pat. No. 5,768,640, for example, to provide two subsystems: (1) a subsystem for automatically labeling, cataloging and describing images and other data and (2) a subsystem for archiving, searching and retrieving images and other data based on their content.

Referring to the drawing figures, the subsystem for automatically labeling cataloging and describing images and other data is comprised of (1) a capturing and recording subsystem 10 comprising a camera or sensor 14, (2) a display subsystem 20 that permits displaying the information related to labeling, cataloging and description of the content of the images and other data, and (3) a description database subsystem 27 which contains descriptions of the contents of images 29 and other data indexed to location, orientation, field of view and time of capture using a camera or a sensor 14.

The system for archiving, searching and retrieving images and other data based on their content comprises two subsystems: (1) as archiving subsystem and (2) a searching and retrieving subsystem.

### System for Labeling, Cataloging and Describing

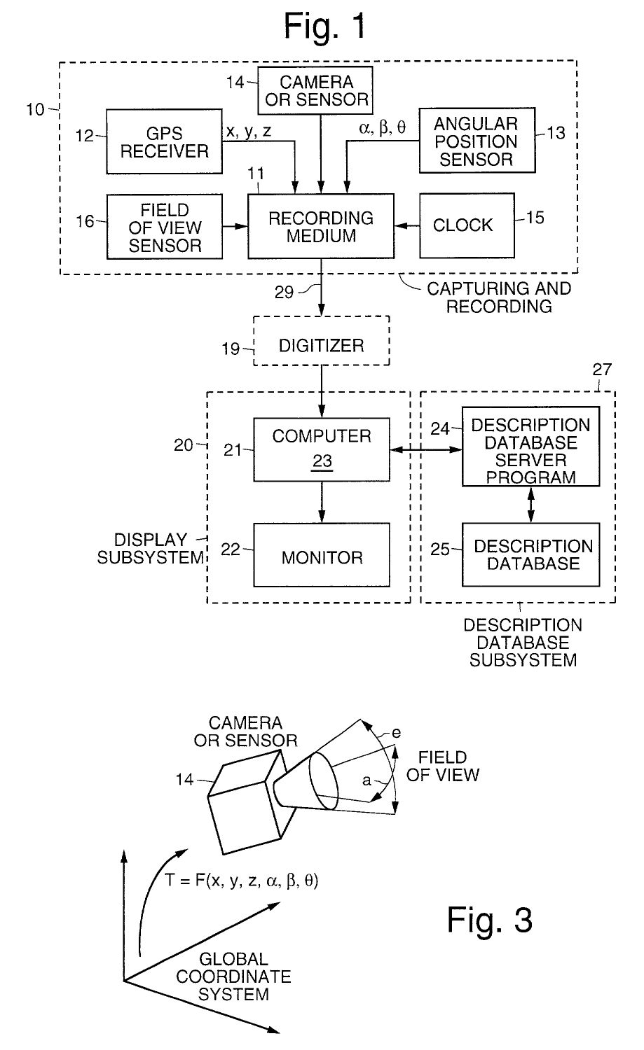

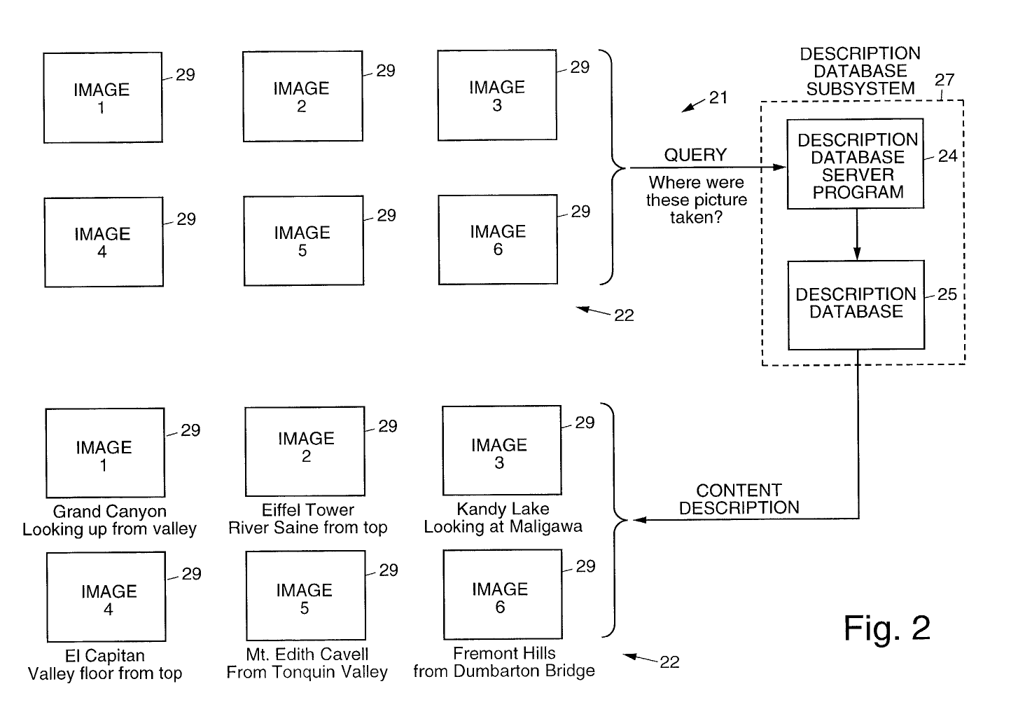

Referring to FIGS. 1 and 2, they show a system 10 for labeling, cataloging and describing images and other data. FIG. 1 is a block diagram illustrating an exemplary capturing and recording subsystem 10, a display subsystem 20 and a description database subsystem 27 in accordance with the principles of the present invention.

It is to be understood that the capturing and recording apparatus 10 may comprise a camera 14 that records photographic images 29, or may comprise a sensor 14 that records data other than photographic images 29. Typical sensors 14 that may be used to acquire and store data (or images 29) other than photographic images 29, include sound sensors, ultrasonic sensors and probes, diagnostic medical ultrasound sensors and probes, X-ray detectors and cameras, MRI scanners, CT scanners, radar imagers, sonar imagers, motion picture cameras, and sensors for recording electronic representations of smell and taste.

The exemplary capturing and recording apparatus 10 is used to record one or more images 29 (FIG. 2) and other data along with the position, orientation and field of view of the camera or sensor 14 when the images or other data are captured and the time of data capture. A clock 15 is provided for indicating the time when the image 29 or other data is captured. The position, orientation, field of view and time data are recorded in the header of a computer file containing the image and other data, for example. Subsequent to recording, the image 29 and other data containing the position, orientation, field of view and time data are digitized if they are not already in digital form and transferred to a display system 20 comprising a computer 21 where they are viewed on a monitor 22.

The exemplary capturing and recording apparatus 10 comprises a recording medium 11 for recording the images 29 and other data. The recording medium 11 may be an analog recording medium, a digital recording medium, photographic film, a magnetic recording medium, optical recording medium, magneto-optical recording medium, holographic recording medium or a RAM, for example. The capturing and recording apparatus 10 includes a Global Positioning System (GPS) receiver 12 that determines the location of the camera or sensor 14 when an image 29 is taken. Any system that can track position of the camera or sensor 14 can replace or supplement the GPS system. Once such system is based on triangulation of radio transmitting and receiving antenna towers. Such systems are being used in cellular phones to track their locations. The clock 15 also outputs the time when the image 29 is taken. The capturing and recording apparatus 10 also includes an angular position sensor 13 that detects the orientation of the axis of the camera or sensor 14 when the image 29 or other data is captured.

The apparatus 10 also includes a field of view sensor 16 that detects the field of view of the image or other data. For images acquired using a camera, motion picture camera, ultrasonic probes or sensors, the field of view can be described by using two parameters: the azimuth extent, a, and the elevation extent, e. In some types of sensors, the field of view may be described using more or fewer parameters. The field of view sensor may sense the field of view by electronically communicating with the camera or sensor 14 that captures the image or other data. For an optical camera, the field of view is a function of the F-number, and the lens aperture. Since these quantities are known to the camera or sensor 14, it may electronically communicate these quantities to the field of view sensor. The field of view sensor may sense the F-number and the lens aperture used to capture the image and convert them into a set of parameters describing the field of view of the camera.

Data derived from the GPS receiver 12, the angular position sensor 13 and the field of view sensor 16 are written into the recording medium 11 when the image 29 or other data are captured. In a preferred embodiment of the present invention, parameters, (x, y, z, α, β, θ, a, e, t), are written to the recording medium 11 along with the image 29 or other data. FIG. 3 illustrates the use of these parameters in accordance with the principles of the present invention. The parameters “x”, “y”, and “z” correspond to coordinates (the physical location) of the camera or sensor 14 at the time the image 29 or the other data are captured. The parameters “α”, “β”, and “θ” correspond to the angular orientation of the camera or sensor 14 at the time the image 29 or other data are captured. The parameters (x, y, z, α, β, θ) define the geometric transformation, T, between a global coordinate system and the camera or sensor 14. T is a function of (x, y, z, α, β, θ). The parameters “a” and “e” correspond to the field of view of the camera or sensor 14 at the time the image 29 or other data are captured. The field of view of the camera or sensor 14 may be described using other parameters as well. In that case the present invention includes those as well. The parameter “t” corresponds to the time that the image 29 or other data is captured. Other parameters of the image 29 or other data capture, such as the shutter speed, film speed, type of film used and local temperature may also be recorded. When the image 29 or other data are recorded in the recording medium 11, the parameters associated with each image 29 or other data preferably includes at least a few of the parameters, (x, y, z, α, β, θ, a, e, t).

After taking the images 29 or other data, and upon return to home or office, the images 29 or other data and the associated (x, y, z, α, β, θ, a, e, t) parameters and, in the case of a camera, other parameters such shutter speed, film speed, type of film used and local temperature, are digitized, using a digitizer 19 if the data is not already in a digital form, uploaded into the computer 21, and viewed by a user on the monitor 22 as shown in FIG. 2 using a computer program 23 running on the computer 21. The computer program 23 may be a program written using HTML, Java™, or Jini™ (by Sun Microsystems, Palo Alto, Calif.) programming languages, running in conjunction with a web browser such as Netscape Navigator™ (by Netscape Communications Corporation, Mountain View, Calif.) or Internet Explorer™ (by Microsoft Inc., Redmond, Wash.).

The position of the camera or sensor 14 may also be determined using the cellular phone technology instead of using the GPS receiver 12. Triangulation of radio transmitting and receiving antenna towers is one such method. There are two versions in use: (a) time difference of arrival (TDOA), and (b) angle of arrival (AOA).

In TDOA, a transmitter, usually located in the hands of a user transmits its current time. Several receiving towers in the area receives the signal, extract the time signature and compare it to the time of their local clocks and estimate the time the signal took to reach each receiving antenna. The clocks in the transmitter and the receivers are all synchronized. Knowing the speed of propagation, the linear distance from the transmitter to each receiving antenna can be computed. Triangulation of the distances yields the location the transmitter.

In AOA, a transmitter, usually located in the hands of a user transmits a signal. Several receiving towers in the area receives the signal, and using the radiation pattern of each antenna and using the received signal strength or other methods, estimate the direction of the transmitter in reference to each receiver. Triangulation of the angles yields the location of the transmitter.

In yet another method named location pattern matching (LMP), a transmitter, usually located in the hands of a user transmits a signal. Several receiving towers in the area receive the signal and compare the received signal to those stored in a signal database. Due to multi-path reflections a signal sent from each location in the cell carries a certain signature. Comparing the received signal to those in a signal database can thus provide an estimate of the location of the transmitter.

The present invention may comprise a sensor 14 that is used to capture data other than photographic images 29. For example, data can be captured using sound sensors, ultrasonic sensors and probes, diagnostic medical ultrasound sensors and probes, X-ray detectors and cameras, MRI scanners, CT scanners, radar imagers, sonar imagers, motion pictures cameras, and sensors for recording electronic representations of smell. This data can be then stored and presented to the user using the present invention.

The description database 25 may reside in a single computer or distributed in several computers networked together. The description database 25 may be expanded over time by requesting general public to send in images 29 or other data, along with the position, orientation, field of view and other parameters of the camera or sensor 14 that captured the images 29 or other data and a description of the content of the images 29 and other data to the description database 25. Such information can be submitted to the description database 25 by using the Internet using web browsers. This information may then be used to augment the description database 25 in an on-going fashion. Therefore, as time goes on, the description database 25 will become more exhaustive.

FIG. 2 illustrates operation of the present invention. FIG. 2 shows exemplary representation of images 29 taken using the capturing and recording apparatus 10 and displayed on the monitor 22 by the computer program 23 running on the computer 21, assisted by the description database apparatus 27. The images 29 contain parameters (in the image header) describing the location, orientation, field of view and time of image capture using the camera or sensor 14.

The computer program 23 on the computer 21 displays the images 29, and extracts the (x, y, z, α, β, θ, a, e, t) and any other data from the image header, and sends some or all of the parameters to a description database server program 24, which may be located on a local storage medium (hard disc) of the computer 21 or on a remote computer 27 connected to the computer 21 via the internet or other network. The description database server program 24 then queries a description database 25 to output a textual, diagrammatic, pictorial, audio, video and/or other multimedia description of the image 29 having the parameters (x, y, z, α, β, θ, a, e, t). The description database 25 is populated with textual, diagrammatic, pictorial, audio, video and/or other multimedia descriptions associated with selected parameters and indexed to all or some of the parameters in the set (x, y, z, α, β, θ, a, e, t).

The response from the description database server program 24 may be textual, diagrammatic, pictorial, audio, video and/or other multimedia. For example, a textual description may take the form: “Yosemite Valley viewed from Glacier Point. Also visible: Half Dome, High Sierra and Merced River”. This is one possible example, and the actual description will vary depending upon where the image 29 was taken.

The description is returned by the description database program 24 to the computer program 23 running on the computer 21, which presents it on the monitor 22 for the user to see, hear or experience. The computer 21 may also store the description in the local storage medium and/or transfer it to another computer program, such as an image enhancement program similar to Adobe Photoshop™ (Adobe Systems Inc., San Jose, Calif.), for further processing and storage.

### System for Archiving, Searching and Retrieving

Position, orientation and field of view data associated with the images 29 or other data may also be processed to facilitate fast and effective archiving, searching and retrieving of image or other data.

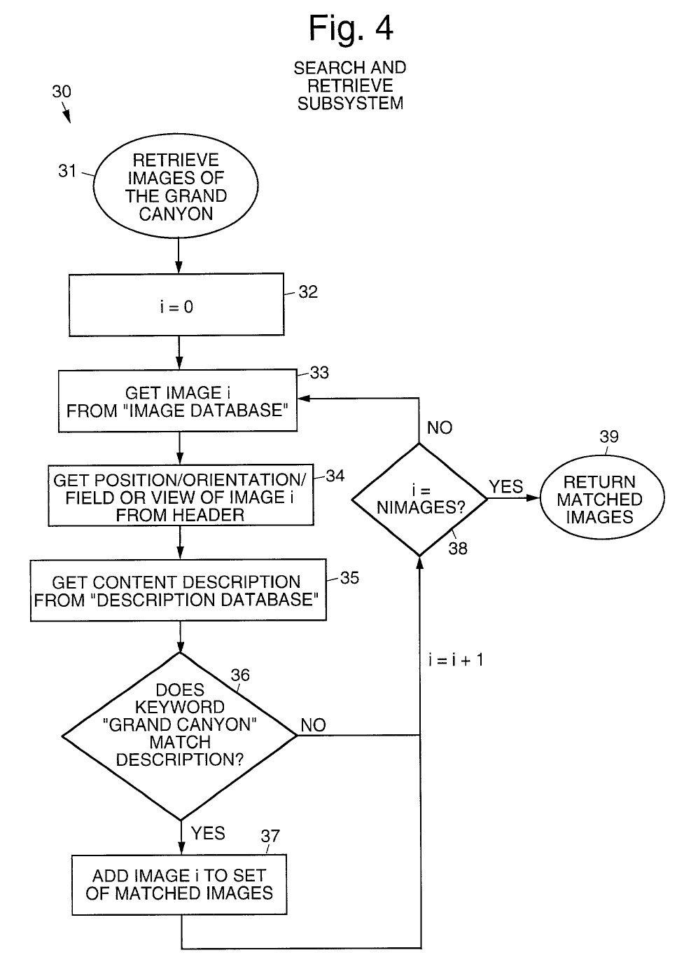

FIG. 4 is a flow diagram that illustrates an exemplary method 30 in accordance with the principles of the present invention for use in searching and retrieving images 29 and other data. All or some of the (x, y, z, α, β, θ, a, e, t) parameters associated with each image 29 are sent to the description database server program 24. The description database server program 24 returns a description of the content of the camera or sensor 14 based on the location, orientation and the field of view, or a subset thereof, of the camera or sensor 14. Search keywords are then matched against the returned description. The keywords may be in the form of textual, diagrammatic, pictorial, audio, video and/or other multimedia data. All images 29 or other data successfully matching the search keywords are returned.

More particularly, the method 30 shown in FIG. 4 starts by a user making a request to retrieve 31 images 29 of the Grand Canyon, for example, from an image database. An image counter is initialized 32. The number of images in the image database is given by the symbol, Nimages. A request is made to read in 33 an image 29 from the image database. The position, orientation, field of view and time data of the image 29 is obtained 34 from the image header. The header may be part of the file containing the image or may reside in a separate file. A description of the content of the image 29 is generated 35 by querying the description database server program 24 and using the description database 25. Note that the description database and the image database are separate entities. A determination 36 is made if the keyword (such as “Grand Canyon”) matches the description. If the keyword matches the description, then the image 29 is added 37 to a set of matched images. The image counter is incremented and a determination 38 is made to see if the final image 29 in the image database has been reached. If the final image 29 has been reached, then all matched images 29 are returned 39 to the user, thus completing the image retrieval process in response to the keyword search. If the final image 29 has not been reached, then the method 30 loops to retrieve 33 the next image 29 from the image database until all matching images 29 are found and retrieved.

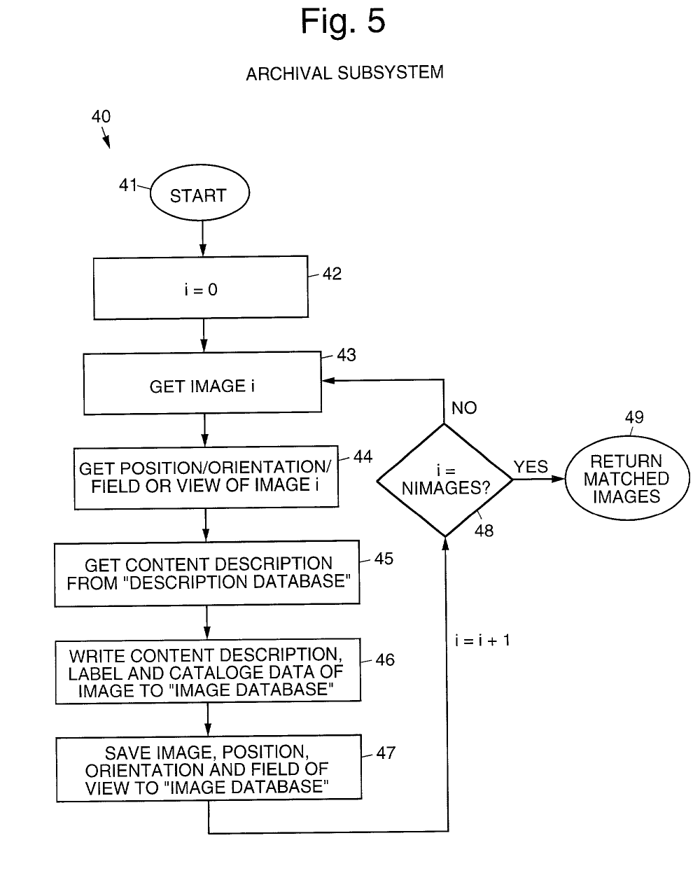

FIG. 5 is a flow diagram illustrating an exemplary method 40 for use in archiving an image 29 along with a description of the content of the image 29. The exemplary method 40 comprises the following steps. The method 40 is handed over a set of images 29 for archiving. In step 41, the process starts and an image counter is initialized 42. The number of images to process is given by the symbol Nimages. In step 44, a request is made to read in an image 29 from the set of images handed over to the method 40. The position, orientation, field of view and time data of the image 29 is obtained 44 from the image header. A description of the content of the image 29 is generated 45 by querying the description database server program 24 and using the description database 25. The description is then written 46 into the image database. If the image and its parameters are not already in the image database, the image and its parameters (position, orientation, field of view and time) are written 47 into the image database. The image counter is incremented and a determination 48 is made to see if the final image 29 in the set of images being processed has been reached. If the final image has been reached the method 40 stops 49. Otherwise, the method 40 loops to retrieve 43 the next image 29 from the set of images being processed until all images are processed.

In implementing the present invention, the parameters (x, y, z, α, β, θ, a, e, t) or a subset thereof relating to the image 29 or other data are sent to a description database program that queries the description database, receives a description of the content of the image 29 or other data, and presents the received description on the monitor 22, stores the description in a local memory and/or sends it to another computer for processing and storage.

In one embodiment of the present invention, the parameters (x, y, z, α, β, θ, a, e, t) or a subset thereof are recorded and an image 29 or other data is captured using a sensor that captures and records sound, ultrasound, diagnostic medical ultrasound, X-ray, MRI, CT, radar, sonar, motion pictures, or electronic representations of smell and taste, wherein the (x, y, z) data are acquired using a GPS receiver or a technique using triangulation of radio transmitting or receiving antenna towers.

In another embodiment, the parameters (x, y, z, α, β, θ, a, e, t) or a subset thereof and data acquired using a sensor that captures and records sound, ultrasound, diagnostic medical ultrasound, X-ray, MRI, CT, radar, sonar, motion pictures, or electronic 10 representations of smell and taste, are sent to a description database program that queries a description database, receives a description of the content of the image 29 or other data, displays the received description on a monitor, stores the description in a local memory and/or sends it to another computer for processing and storage.

In another embodiment, databases containing data corresponding to images, sound, ultrasound, diagnostic medical ultrasound, X-ray, magnetic resonance imaging MRI, CT, radar and sonar, motion pictures, or electronic representations of smell and taste are searched using the parameters (x, y, z, α, β, θ, a, e, t) or a subset thereof, the parameters are translated into a description of the content of the data using a description database program, keywords are matched to the description, and the description is presented with the data to the user.

Thus, indexing and database apparatus and methods that provide for automatic labeling, cataloging and describing the content of images and other data using position, orientation, field of view, time and other data recorded with the images have been disclosed. In addition, indexing and database apparatus and methods that provide for archiving, searching and retrieving images and other data based on descriptions of their content have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for generating a description of the content of an image comprising the steps of:
(a) reading in parameters associated with the image, wherein the parameters include the parameters describing the location of the sensor when the image is captured,
(b) querying a description database indexed to the parameters in (a),
(c) collecting the response corresponding to the description of the content of the image from the description database in response to (b).

2. The method as recited in claim 1, wherein the parameters include the parameters describing the orientation of the axis of the sensor when the image is captured.

3. The method as recited in claim 1, wherein the parameters include the parameters describing the field of view of the sensor when the image is captured.

4. The method as recited in claim 1, wherein the parameters include the parameters describing the time of image capture.

5. The method as recited in claim 1, wherein the location of the sensor when the image is captured is sensed using a GPS receiver.

6. The method as recited in claim 1, wherein the location of the sensor when the image is captured is sensed using a triangulation scheme of radio transmitting and receiving antenna towers.

7. The method as recited in claim 6 wherein the triangulation scheme is selected from a group consisting of time difference of arrival and angle of arrival.

8. The method as recited in claim 1, wherein the location of the sensor when the image is captured is sensed using a pattern-matching scheme.

9. The method as recited in claim 1, wherein the description contained in the database includes textual, diagrammatic, pictorial, audio, video and multimedia descriptions of images indexed to the parameters.

10. The method as recited in claim 1, wherein the sensor includes a camera.

11. The method as recited in claim 1 wherein the sensor is selected from a group consisting of sound sensors, ultrasonic sensors, diagnostic medical ultrasound scanners, X-ray detectors, magnetic resonance imaging scanners, computed tomography scanners, radar imagers, sonar imagers, motion pictures cameras, and sensors for producing electronic representations of smell and taste.

12. A method for archiving an image in a database of images comprising the steps of:
(a) generating a description of the content of the image using the method claimed in claims 1-11; and
(b) saving the description in the database.

13. A method for searching and retrieving images from a database of images based on their content comprising the steps of:
(a) generating a description of the content of an image in the database of images using the method claimed in claims 1-11; and
(b) matching a keyword to the description.

14. Apparatus for generating the content of an image comprising the steps of:
(a) a sensor for capturing an image,
(b) a parameter sensor for sensing parameters associated with an image wherein the parameters include the parameters describing the location of the sensor when the image is captured,
(c) a recording medium for recording the image and associated parameters;
(d) a description database containing descriptions of the contents of images indexed to the parameters in (b),
(e) an image display system comprising a computer, a monitor and at least one computer program 23, for viewing the image, for reading in the parameters, for querying the description database in (d), for generating a description of the content of the image, and for presenting the description of the image to the user.

15. The apparatus as recited in claim 14 wherein the parameters include the parameters describing the orientation of the axis of the sensor when the image is captured.

16. The apparatus as recited in claim 14 wherein the parameters include the parameters describing the field of view of the sensor when the image is captured.

17. The apparatus as recited in claim 14 wherein the parameters include the parameters describing the time of image capture.

18. The apparatus as recited in claim 14 wherein the location of the sensor when the image is captured is sensed using a GPS receiver.

19. The apparatus as recited in claim 14 wherein the location of the sensor when the image is captured is sensed using a triangulation scheme of radio transmitting and receiving antenna towers.

20. The apparatus as recited in claim 19 wherein the triangulation scheme is selected from a group consisting of time difference of arrival and angle of arrival.

21. The apparatus as recited in claim 14 wherein the location of the sensor when the image is captured is sensed using a pattern-matching scheme.

22. The apparatus as recited in claim 14 wherein the description contained in the database includes textual, diagrammatic, pictorial, audio, video and multimedia descriptions of images 29 indexed to the parameters.

23. The apparatus as recited in claim 14 wherein the sensor includes a camera.

24. The apparatus as recited in claim 14 wherein the sensor is selected from a group consisting of sound sensors, ultrasonic sensors, diagnostic medical ultrasound scanners, X-ray detectors, magnetic resonance imaging scanners, computed tomography scanners, radar imagers, sonar imagers, motion pictures cameras, and sensors for producing electronic representations of smell and taste.

25. The apparatus as recited in claim 14 wherein the recording medium is selected from a group consisting of an analog recording medium, a photographic film, an analog video tape, a digital recording medium, a random access memory, a compact disc, a digital video disc, a digital video tape, a magnetic recording medium, an optical recording medium or magneto-optical recording medium.

26. The apparatus as recited in claim 14 further comprising a digitizer for digitizing the image and associated parameters.

27. The apparatus as recited in claim 14 wherein the description database is located on a local storage medium.

28. The apparatus as recited in claim 14 wherein the database is located on a remote computer connected to the computer 21.
